(19) United States
(12) Patent Application Publication
(10) Pub. No.: US 2019/0306701 A1
(43) Pub. Date: Oct. 3, 2019

(54) METHOD OF TRANSMITTING AND RECEIVING SECRET DATA WITH MULTIPLE-CHANNEL TRANSCEIVER

(71) Applicant: ELECTRONICS AND TELECOMMUNICATIONS RESEARCH INSTITUTE, Daejeon (KR)

(72) Inventors: Jung Ho MYUNG, Daejeon (KR); Keunyoung KIM, Daejeon (KR); Jihoon SEO, Daejeon (KR)

(21) Appl. No.: 16/193,015

(22) Filed: Nov. 16, 2018

(30) Foreign Application Priority Data
Mar. 27, 2018 (KR) 10-2018-0034910

(51) Int. Cl. H04W 12/00; H04K 1/10

(52) U.S. Cl. CPC H04W 12/001; G06F 7/588; H04K 1/10

(57) ABSTRACT

A method of transmitting secret data includes determining a parameter value used to encode secret data based on a number of independent radio channels between a transmitter and a receiver corresponding to the transmitter, generating predetermined variables used to divide the secret data based on the parameter value, encoding the secret data based on the parameter value and the predetermined variables, and transmitting the encoded secret data to the receiver.

### CROSS-REFERENCE TO RELATED APPLICATION(S)

This application claims the priority benefit of Korean Patent Application No. 10-2018-0034910, filed Mar. 27, 2018, in the Korean Intellectual Property Office, the disclosure of which is incorporated herein by reference for all purposes.

### BACKGROUND

### 1. Field of the Invention

One or more example embodiments relate to a method of transmitting and receiving secret data with multiple-channel transceiver.

### 2. Description of Related Art

Generally, a security of a wireless communication channel may be configured based on encryption. For example, a transmitting end may encrypt and transmit data based on a previously shared key, and a receiving end may receive secret data by decrypting the encrypted data. However, an encryption-based secret data transmission, method may not guarantee a safety because an encryption key can be exposed due to an enormous computing capability of a quantum computer.

### SUMMARY

An aspect provides technology for encrypting secret data using, a parameter value determined based on a number of independent radio channels between a transmitter and a receiver and predetermined variables generated by a random number generator, thereby protecting the secret data through a process of dividing, and assembling the secret data even when an encryption key is exposed.

Another aspect also provides technology for selectively controlling a reception rate of a receiver and an eavesdropping rate of an eavesdropper by encoding secret data by adjusting a parameter value determined based on a number of independent radio channels between a transmitter and a receiver and predetermined variables generated by a random number generator.

Still another aspect also provides technology for safely transmitting secret data by encoding the secret data based on predetermined variables generated by a random number generator unless the predetermined variables are exposed.

Yet another aspect also provides technology for enhancing a security of secret data by blocking an environment where an eavesdropper terminal can eavesdrop. Using this technology, all items of data fragmented from the secret data may not be acquired even when predetermined variables generated by a random number generator are exposed.

According to an aspect, there is provided a method of transmitting secret data, the method including determining a parameter value used to encode secret data based on a number of independent radio channels between a transmitter and a receiver corresponding to the transmitter, generating predetermined variables used to divide the secret data based on the parameter value, encoding the secret data based on the parameter value and the predetermined variables, and transmitting the encoded secret data to the receiver.

The determining of the parameter value may include predicting the number of independent radio channels between the transmitter and the receiver based on radio channel information of the transmitter and the receiver, a number of antennas of the transmitter, and a number of antennas of the receiver.

The determining of the parameter value may include determining a parameter value including N and K based on the number of independent radio channels, N being a number of partitions by which the secret data is to be divided into data fragments and K being a minimum number of data fragments required to decode the secret data among the divided data fragments.

The generating of the predetermined variables may include generating predetermined variables used to divide the secret data based on the parameter value using a random number generator.

The predetermined variables may include at least one of a predetermined decimal value used to divide the secret data, K−1 random variables, K being a minimum number of data fragments required for decoding the secret data, an index value of a transmission channel, and a variable for data fragments required to decode the secret data.

The encoding of the secret data may include encoding the secret data into data fragments corresponding to a number of partitions of the secret data based on the parameter value and the predetermined variables.

The encoding of the secret data into the data fragments may include encoding the secret data by applying the parameter value and the predetermined variables to a shared encoding function and dividing the secret data into the data fragments.

The transmitting of the encoded secret data to the receiver may include modulating the encoded secret data into a transmission symbol based on a binarization and modulation scheme and transmitting the modulated transmission symbol to the receiver based on a beamforming scheme.

The transmitting of the modulated transmission symbol to the receiver may include transmitting the modulated transmission symbol to the receiver through a channel path assigned based on the number of independent radio channels.

The transmitting of the modulated transmission symbol to the receiver may include determining a transmission power used to transmit the modulated transmission symbol based on a preset power distribution value based on the radio channel information of the transmitter and the receiver and transmitting the modulated transmission symbol to the receiver based on the determined transmission power.

The method may further include sharing, with the receiver, at least one of the parameter value, the predetermined variables, and an encoding function used for the encoding.

The radio channel information of the transmitter and the receiver may be determined based on channel information sent from the receiver as a feedback.

According to another aspect, there is also provided a method of receiving secret data, the method including estimating divided secret data by filtering and demodulating a signal transmitted from a transmitter and decoding secret data from the divided secret data based on an encoding function used for encoding the divided secret data and receiving the secret data.

The decoding may include decoding the secret data from the divided secret data inversely using the encoding function used for encoding the divided secret data based on a parameter value and predetermined variables shared with the transmitter.

According to still another aspect, there is also provided a transmitter including a processor configured to determine a parameter value used to encode secret data based on a number of independent radio channels between a transmitter and a receiver corresponding to the transmitter, generate predetermined variables used to divide the secret data based on the parameter value, and encode the secret data based on the parameter value and the predetermined variables, and a communication interface configured to transmit the encoded secret data to the receiver using a plurality of antennas.

The processor may be configured to predict the number of independent radio channels between the transmitter and the receiver based on radio channel information of the transmitter and the receiver, a number of antennas of the transmitter, and a number of antennas of the receiver.

The processor may be configured to determine a parameter value including N and K based on the number of independent radio channels, N being a number of partitions by which the secret data is to be divided into data fragments and K being a minimum number of data fragments required to decode the secret data among the divided data fragments.

The transmitter may further include a random number generator configured to generate predetermined variables used to divide the secret data based on the parameter value.

The predetermined variables may include at least one of a predetermined decimal value used to divide the secret data, K−1 random variables, K being a minimum number of data fragments required for decoding the secret data, an index value of a transmission channel, and a variable for data fragments required to decode the secret data.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a model of a communication system including a transmitter and a receiver according to an example embodiment;

FIG. 2 is a flowchart illustrating a method of transmitting secret data according to an example embodiment;

FIG. 3 is a flowchart illustrating a method of receiving secret data according to an example embodiment;

FIG. 4 is a diagram illustrating structures of a transmitter and a receiver according to an example embodiment;

FIG. 5 is a diagram illustrating an operation of a transmitter according to an example embodiment;

FIG. 6 is a diagram illustrating an example of wireless transmission performed by a transmitter and a receiver according to an example embodiment;

FIG. 7 is a diagram illustrating an operation of a receiver according to an example embodiment; and

FIG. 8 is a block diagram illustrating a transmitter according to an example embodiment.

### DETAILED DESCRIPTION

Hereinafter, example embodiments will be described in detail with reference to the accompanying drawings.

It should be understood, however, that there is no intent to limit this disclosure to the particular example embodiments disclosed. On the contrary, example embodiments are to cover all modifications, equivalents, and alternatives falling within the scope of the example embodiments.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

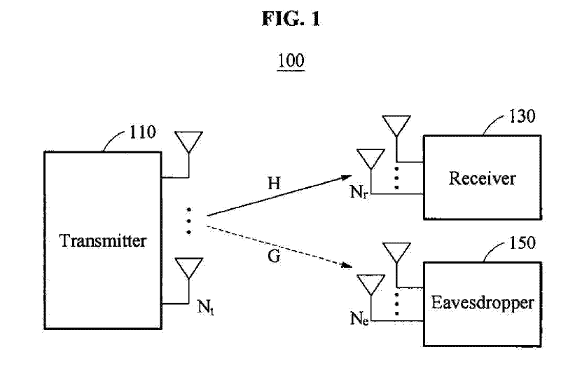

FIG. 1 is a diagram illustrating a model of a communication system including a transmitter and a receiver according to an example embodiment. FIG. 1 illustrates a transmitter 110, a receiver 130, and an eavesdropper 150. The transmitter 110, the receiver 130, and the eavesdropper 150 may each correspond to a communication terminal including multiple antennas. The eavesdropper 150 may correspond to a terminal that decrypts a plaintext using a cryptanalysis technique from secret data or a cipher text monitored in a communication network and acquires information on a communication message as a third party instead of a legitimate participant. The eavesdropper 150 may apply an active attack such as a message forgery or transmission disturbance as well as passive attack such as message tapping.

For example, the transmitter 110 may include Nₜ transmitting antennas, the receiver 130 may include Nᵣ receiving antennas, and the eavesdropper 150 may include Nₑ antennas. Radio channel information H of the transmitter 110 and the receiver 130 may be, for example, Nᵣ×Nₜ matrix information. In FIG. 1, G denotes eavesdrop channel information of the transmitter 110 and the eavesdropper 150.

The transmitter 110 and the receiver 130 may have min(Nₜ, Nᵣ) independent radio channel rank values by a beamforming technique. The radio channel rank value may correspond to a number of radio channels through which the transmitter 110 and the receiver 130 simultaneously transmit min(Nₜ, Nᵣ) items of independent radio data.

The independent radio channel rank value that is obtained using multiple antennas may be applied not only to a communication using a plurality of frequencies or a communication method for transmitting data several times by dividing the data, but also to a communication scheme using a time and a frequency together. The independent radio channel rank value may also be referred to as the number of independent radio channels.

The beamforming technique may correspond to a technique for simultaneously transmitting a plurality of items of data in a space using multiple antennas. When a beamforming technique suitable for the multiple antennas is used, a transmission rate in a point-to-point multiple-input and multiple-output (MIMO) channel of one transmitter and one receiver and a MIMO interference channel in which interference occurs by a plurality of transmitters and a plurality of receivers may be linearly proportional to the number of antennas. In an example embodiment, for example, a transmission and reception beamforming matrix may be constructed by a unitary matrix obtained by performing a singular value decomposition (SVD) in a point-to-point MEMO channel environment and a transmission power may be allocated using a singular value.

The transmitter 110 and the receiver 130 may encrypt secret data using a parameter value determined based on the number of independent radio channels of the transmitter 110 and the receiver 130 and predetermined variables generated by a random number generator, thereby preventing the secret data from being eavesdropped using the eavesdropper 150 in a physical layer through a process of dividing and assembling the secret data irrespective of a presence of an encryption key.

The transmitter 110 and the receiver 130 may encode the secret data by adjusting predetermined variables and a parameter value determined based on the number of independent radio channels of the transmitter 110 and the receiver 130 so as to selectively adjust a reception rate of the receiver 130 and an eavesdropping rate of the eavesdropper 150.

The transmitter 110 and the receiver 130 may encode the secret data using predetermined values generated in a random number generator and data fragments obtained by dividing the secret data, thereby blocking the eavesdropping of the eavesdropper 150 and enhancing a transmission security of the secret data. Operations and structures of the transmitter 110 and the receiver 130 for blocking the eavesdropping of the eavesdropper 150 will be further described later.

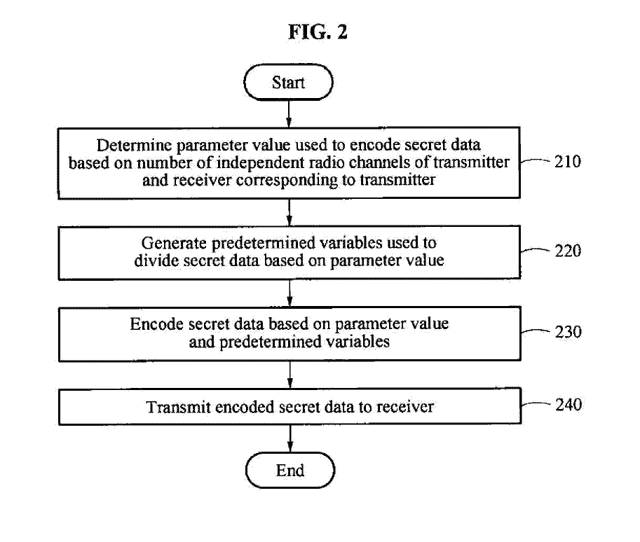

FIG. 2 is a flowchart illustrating a method of transmitting secret data according to an example embodiment. Referring to FIG. 2, in operation 210, a transmitter may determine a parameter value used to encode secret data based on a number of independent radio channels between the transmitter and a receiver corresponding to the transmitter. The transmitter may predict the number of independent radio channels between the transmitter and the receiver based on radio channel information of the transmitter and the receiver, a number of antennas of the transmitter, and a number of antennas of the receiver. The radio channel information of the transmitter and the receiver may be determined based on channel information sent from the receiver as a feedback. The transmitter may determine the parameter value based on the predicted number of independent radio channels. The parameter value may include N and K, N being a number of partitions by which the secret data is to be divided into data fragments and K being a minimum number of data fragments required to decode the secret data among the divided data fragments.

When the radio channel information of the transmitter and the receiver is H, the number of antennas of the transmitter is Nᵣ, and the number of antennas of the receiver is Nₜ, the transmitter may predict min(Nᵣ, Nₜ) as the number of independent radio channels. The transmitter may determine N corresponding to the number of partitions to be, for example, N≤min(Nᵣ, Nₜ) based on min(Nᵣ, Nₜ) that is the number of independent radio channels. Also, the transmitter may determine K corresponding to the minimum number of data fragments required to decode the secret data to be, for example, K≤N.

In operation 220, the transmitter may generate predetermined variables used to divide the secret data based on the parameter value. The transmitter may use, for example, a random number generator to generate the predetermined variables used to divide the secret data based on the parameter value. The predetermined variables may include, for example, a predetermined decimal value used to divide the secret data, K−1 random variables, an index value of a transmission channel, and a variable for data fragments required to decode the secret data.

In operation 230, the transmitter may encode the secret data based on the parameter value and the predetermined variables. The transmitter may encode the secret data into data fragments corresponding to the number of partitions of the secret data based on the parameter value and the predetermined variables. The transmitter may encode the secret data by applying the parameter value and the predetermined, variables to a shared encoding function and dividing the secret data into the data fragments.

In operation 240, the transmitter may transmit the encoded secret data to the receiver. The transmitter may modulate the encoded secret data into a transmission symbol based on a binarization and modulation scheme and transmit the modulated transmission symbol to the receiver based on a beamforming scheme. In this example, a modulation scheme, for example, binary phase shift keying (BPSK) and quadrature phase-shift keying (QPSK) may be used. In operation 240, the transmitter may transmit the modulated transmission symbol to the receiver through a channel path assigned based on the number of independent radio channels. Also, the transmitter may determine, a transmission power used to transmit the modulated transmission symbol based on a preset power distribution value based on the radio channel information of the transmitter and the receiver, and transmit the modulated transmission symbol to the receiver based on the determined transmission power.

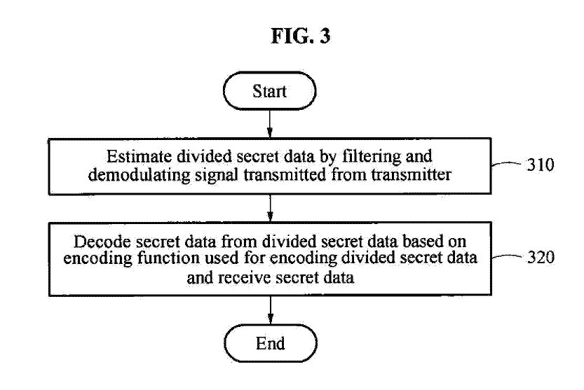

FIG. 3 is a flowchart illustrating a method of receiving secret data according to an example embodiment. Referring to FIG. 3, in operation 310, a receiver may estimate divided secret data by filtering and demodulating a signal transmitted from a transmitter.

In operation 320, the receiver may decode secret data from the divided secret data based on an encoding function used for encoding the divided secret data and receiving the secret data. For example, the receiver may decode the secret data from the divided secret data inversely using the encoding function used for encoding the divided secret data based on a parameter value and predetermined variables shared with the transmitter. In this example, the transmitter and the receiver may share at least one of the parameter value, the predetermined variables, and the encoding, function used for the encoding.

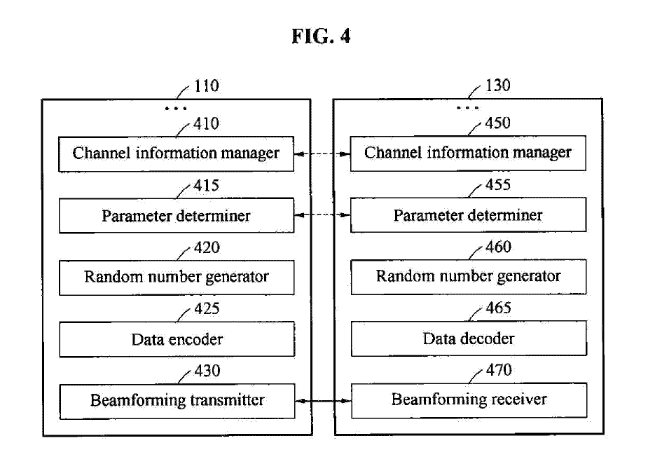

FIG. 4 is a diagram illustrating structures of a transmitter and a receiver according to an example embodiment. FIG. 4 illustrates structures of the transmitter 110 and the receiver 130.

The transmitter 110 may include a channel information manager 410, a parameter determiner 415, a random number generator 420, a data encoder 425, and a beamforming transmitter 430.

The channel information manager 410 may manage radio channel information of the transmitter 110 and the receiver 130. The radio channel information may be used to determine a parameter value for secret data transmission and beamforming design of the transmitter 110. The channel information manager 410 may receive channel information measured by a channel information manager 450 of the receiver 130 as a feedback to manage the channel information and/or perform a synchronization.

The parameter determiner 415 may determine a parameter value used for divisional encoding of secret data. Based on the radio channel information, the parameter determiner 415 may determine N, N being a number of partitions by which the secret data is to be divided into data fragments, and data fragments required for success in demodulation of the secret data, for example, K being the minimum number of data fragments required to decode the secret data and

In the present disclosure, the data fragment may refer to divided data that obtained by performing an encoding process on raw data instead of simply dividing the raw data. Thus, the raw data may not be predicted directly from the data fragment.

For example, the parameter determiner 415 may enhance a security by setting a large parameter value. However, in this example, a complexity may also increase in a process of decoding the secret data. Thus, the parameter determiner 415 may determine the parameter value through any one or a combination of the following procedures.

The parameter determiner 415 may determine the parameter value by using repetitively, any one of, or combinations of, for example, a method of setting a fixed parameter value in advance, a method of dynamically setting a parameter value based on a network traffic situation, an operator purpose, and/or a service type corresponding to a random number generator and a random number generation algorithm, a method of setting a parameter value by applying a user request based on an external interface, and sharing and/or negotiation between a transmitter and a receiver through a data communication.

In a radio channel situation of a transmitter and a receiver in which, for example, Nₜ=7 and Nᵣ=6, the parameter determiner 415 may set parameter values, for example, N=5 and K=3, or N=6 and K=5.

The random number generator 420 may generate predetermined variables to dividing the secret data to correspond to the parameter values N and K determined by the parameter determiner 415. The random number generator 420 may include a random number generator or a random number generation algorithm.

The random number generator 420 may generate, for example, a predetermined decimal number p used for dividing the secret data, K−1 random variables, K being a minimum number of data fragments required to decode the secret data, an index value of a transmission channel, and a variable (share-i value) for data fragments required to decode the secret data. Also, the random number generator 420 may additionally generate a predetermined variable or random number as necessary.

For example, when N=5 and K=3, the random number generator 420 may generate predetermined variables such as a predetermined decimal value, for example, p=9839, (3-1) random variables, for example, a₁=166 and a₂=94, “3” being the minimum number of data fragments required for demodulating the secret data, transmission channel index values {1, 3, 4, 5, 6}, and variables {1, 2, 3, 4, 5} for the data fragments required for demodulating the secret data.

The parameter determiner 415 and the random number generator 420 of the transmitter 110 may be similarly configured when compared to a parameter determiner 455 and a random number generator 460 of the receiver 130, or share information determined or generated in the parameter determiner 415 and the random number generator 420 of the transmitter 110 with the parameter determiner 455 and the random number generator 460.

Depending on an example, the parameter determiner 415 and the random number generator 420 and/or the parameter determiner 455 and the random number generator 460 may perform one process integrally.

The data encoder 425 may divide the secret data into N data fragments using the parameter value and the predetermined variables determined in the parameter determiner 415 and the random number generator 420. For example, when a data fragment among the N data fragments is defined as “share”, the data encoder 425 may divide the secret data to be “share” using various methods.

The data encoder 425 may use, for example, a polynomial function to divide the secret data to be an i^{th} share value Si, i≤N as shown in Equation 1.

Sᵢ=(a₀+a₁i+ . . . +a_{K-1}_{ⁱ}^{K-1})mod p. [Equation 1]

In Equation 1, i denotes an index of a share value, predetermined variables a₁ through a_{K-1} denote K−1 random variables, K being a minimum number of data fragments required to decode secret data arbitrarily generated in the random number generator 420, and a₀ denotes secret data. Also, p denotes a predetermined decimal number determined in the random number generator 420 and mod denotes a modulo operation.

Remaining variables other than the secret data a₀ may be values generated in the random number generator 420 of the transmitter 110 and the random number generator 460 of the receiver 130 using the same random number generation algorithm, or values previously shared between the random number generator 420 of the transmitter 110 and the random number generator 460 of the receiver 130.

Although the data encoder 425 uses the polynomial function as a method of dividing secret data, the method is not limited thereto. Instead, any function by which a data fragment “share” different from the secret data is obtained is applicable. Also, predetermined variables used for dividing the secret data may be generated by the random number generator.

When a₀=1234 (secret data), N=5, K=3, p=9839, a₁=166, a₂=94, and share-i values={1, 2, 3, 4, 5}, the data encoder 425 may obtain i^{th} share data Sᵢ divided from the secret data as below.

S₁=(1234+166*1+94*1\hat{ }2)mod p=1494

S₂=(1234+166*2+94*2\hat{ }2)mod p=1942

S₃=(1234+166*3+94*3\hat{ }2)mod p=2578

S₄=(1234+166*4+94*4\hat{ }2)mod p=3402

S₅=(1234+166*5+94*5\hat{ }2)mod p=4414

The beamforming transmitter 430 may modulate or convert the encoded secret data, for example, the divided share through a binarization and modulation scheme. Also, the beamforming transmitter 430 may transmit the modulated transmission symbol to a receiver using the beamforming scheme.

The transmitter and the receiver, each having multiple antennas may obtain min(Nₜ, Nᵣ) independent radio channels through which a plurality of transmission symbols is simultaneously transmitted using the beamforming technique. In this example, the share data, for example, Sᵢ divided in the data encoder 425 may be transmitted to the receiver through a channel path allocated based on a transmission channel index or an independent radio channel index generated in the random number generator 420.

Basically, the beamforming transmitter 430 may evenly set the transmission power used for transmitting the transmission symbol. Alternatively, the beamforming in transmitter 430 may previously set a power distribution value in the parameter determiner and/or the random number generator based on radio channel information of the transmitter and the receiver. In FIG. 4, a solid line connecting the beamforming transmitter 430 and a beamforming receiver 470 represents a physical layer transmission between the transmitter 110 and the receiver 130.

An operation of the beamforming transmitter 430 may be as follows.

When min(Nₜ, Nᵣ)=6, the modulated share values={S₁, S₂, S₃, S₄, S₅}, and the transmission channel index values={1, 3, 4, 5, 6}, the beamforming transmitter 430 may transmit five data fragments, for example, the shares S₁, S₂, S₃, S₄, and S₅ to be used for beamforming to the receiver 130 by matching S₁ to an, index 1, S₂ to an index 3, S₃ to an index 4, S₄ to an index 5, and S₅ to an index 6.

The receiver 130 may include the channel information manager 450, the parameter determiner 455, the random number generator 460, a data decoder 465, and the beamforming receiver 470.

Since the description of the operations of the channel information manager 410, the parameter determiner 415, and the random number generator 420 of the transmitter 110 is also applicable to operations of the channel information manager 450, the parameter determiner 455, and the random number generator 460, repeated description will be omitted. Hereinafter, operations of the data decoder 465 and the beamforming receiver 470 will be described.

The beamforming receiver 470 may receive a signal transmitted from the beamforming transmitter 430 through the physical layer transmission. The beamforming receiver 470 may estimate the divided secret data, for example, the transmitted data “share” by filtering and/or demodulating the signal transmitted by the beamforming transmitter 430.

The data decoder 465 may assemble the divided secret data, for example, the estimated data “share” to obtain the secret data. The data decoder 465 may assemble or restore the transmitted secret data using an encoding function or an inverse function of the encoding function used by the data encoder 425 to divide the secret data. When assembling or restoring the secret data, the data decoder 465 may assemble or restore the secret data based on information, for example, the radio channel information, the predetermined variables, and the parameter value determined or generated in the channel information manager 450, the parameter determiner 455, and the random number generator 460.

When the data encoder 425 has encoded the secret data using the aforementioned polynomial function, the data decoder 465 may assemble or restore the secret data by calculating a Lagrange interpolating polynomial as shown in Equation 2.

$${\sum }_{j = 1}^{K} {\hat{S}}_{j} \cdot [ {\prod }_{k = 1 , k \neq j}^{K} \frac{i - {i}_{k}}{{i}_{j} - {i}_{k}} ] mod p , \qquad [ Equation 2 ]$$

In Equation 2, i denotes a share value index, j denotes an index of an antenna receiving a transmitted share value or an independent channel index, iⱼ denotes an index value of i corresponding to a j^{th} ordinal position, iₖ denotes an index value of i corresponding to a k^{th} ordinal position that does not overlap with j, p denotes a predetermined decimal value determined in the random number generator 460, mod denotes a modulo operation, and Ŝⱼ denotes a value of share received by a j^{th} antenna.

For example, N=5 and K=3, N and K being the parameter values. In addition, p=9839, a₁=166, and a₂=94, p, a₁ and a₂ being the variables generated by the random number generator 460 of the receiver 130. Also, share-i values={1, 2, 3, 4, 5}, and receiving channel index values={1, 3, 4, 5, 6}.

The data decoder 465 may obtain “1234+166 i+94 i\hat{ }2” through a calculation performed by applying share values, for example, 1942, 3402, and 4414 received from the transmitter 110 to the Lagrange interpolating polynomial. Here. “1234” may correspond to the secret data.

In Equation 2, if j=1, a value of [ ] may be (i−4)/(2−4)*(i−5)/(2−5)=⅙*i\hat{ }2−3/2*i+10/3. If j=2, a value of [ ] may be (i−2)/(4−2)*(i−5)/(4−5)=−½*i\hat{ }2+7/2*i−5. If j=3, a value of [ ] may be (i−2)/(5−2)*(i−4)/(5−4)=⅓*i\hat{ }2−2*i+8/3. In this example, when multiplying results of j=1, j=2, and j=3 by sj and summating the multiplied results, 1942*(result of j=1)+3402*(result of j=2)+4414 (result of j=3)=1234+166*i+949\hat{ }2 may be obtained.

For example, if N=5 and K=3, number of cases for recovering the secret data may be 10 (=5C3). In this example, the data decoder 465 may recover the secret data using a method of assigning a weighting to each case in an order of high radio channel gains or based on a majority rule.

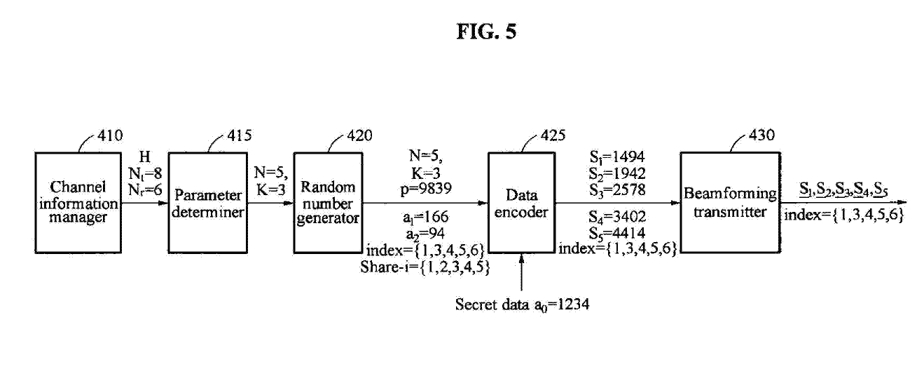

FIG. 5 is a diagram illustrating an operation of a transmitter according to an example embodiment. FIG. 5 illustrates operations performed between elements of a transmitter, for example, the channel information manager 410, the parameter determiner 415, the random number generator 420, the data encoder 425, and the beamforming transmitter 430.

The channel information manager 410 may transmit information including radio channel information H of the transmitter and the receiver, the number of antennas of the transmitter, for example, Nₜ=8, and the number of antennas of the receiver, for example, Nᵣ=6 to the parameter determiner 415.

The parameter determiner 415 may predict the number of independent radio channels, for example, min(Nₜ, Nᵣ) to be provided between the transmitter and the receiver, based on the information (for example, H, Nₜ=8, and Nᵣ=6) received from the channel information manager 410. The parameter determiner 415 may determine a number of partitioned shares required for dividing the secret data and K based on the predicted number of independent radio channels, K being a minimum number of data fragments required to decode the secret data among the divided data fragments. In this example, the number of partitioned shares may correspond to N, N being number of partitions by which the secret data is to be divided into data fragments. The parameter determiner 415 may determine, for example, N=5 and K=3.

The random number generator 420 may generate variables required for dividing the secret data (for example, a predetermined decimal value p=9839, variables of a polynomial function {a₁=166, a₂=94}, transmission channel index values={1, 3, 4, 5, 6}, and predetermined i values input to the polynomial function are {1, 2, 3, 4, 5}) based on the parameters (for example, N=5 and K=3) determined in the parameter determiner 415.

The data encoder 425 may device the secret data a₁=1234 into N (for example, N=5) data fragments, for example, shares using variables generated in the random number generator 420.

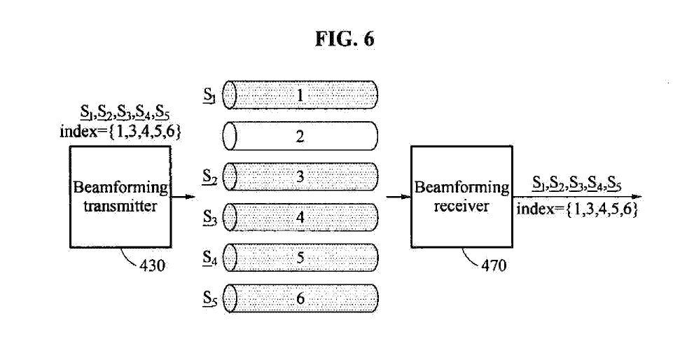

The beamforming transmitter 430 may modulate the N data fragments into transmission symbols and transmit, to the receiver, the transmission symbols based on beamforming using the transmission index values {1, 3, 4, 5, 6}. The beamforming transmitter 430 may be transmitted to the beamforming receiver 470 through a process as described with reference to FIG. 6.

FIG. 6 is a diagram illustrating an example of wireless transmission performed by a transmitter and a receiver according to an example embodiment. FIG. 6 illustrates a process of transmitting a modulated transmission symbol through a channel path allocated based on transmission channel index values {1, 3, 4, 5, 6} among six independent radio transmission channels of the beamforming transmitter 430 and the beamforming receiver 470.

When transmission beamforming and reception beamforming such as an SVD are used, a radio channel H between a transmitter and a receiver having an Nᵣ×Nₜ matrix may have min(Nᵣ, Nₜ) independent radio transmission channels or independent radio channels.

For example, when the number of antennas Nₜ of the transmitter is 8 and the number of antennas Nᵣ of the receiver is 6, the transmitter and the receiver may have six independent radio transmission channels.

As described with reference to FIG. 5, when N=5 and transmission channel index values are {1, 3, 4, 5, 6}, five modulated share values, for example, the modulated transmission symbol transmitted by the beamforming transmitter 430 may be transferred to the beamforming receiver 470 through radio channels of the index, values {1, 3, 4, 5, 6} obtained through beamforming.

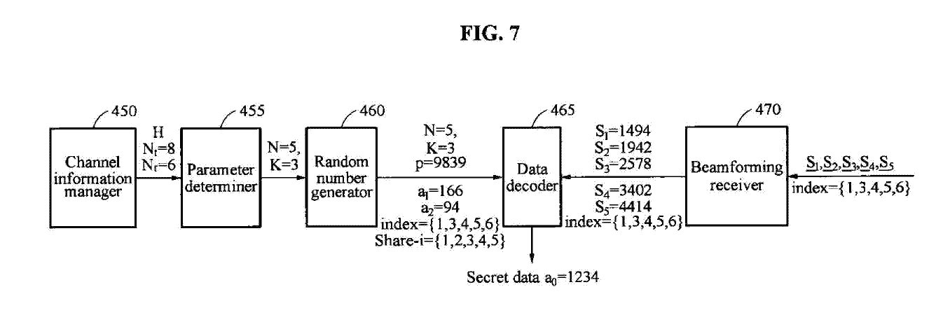

FIG. 7 is a diagram illustrating an operation of a receiver according to an example embodiment. FIG. 7 illustrates operations performed between elements of a receiver, for example, the channel information manager 450, the parameter determiner 455, the random number generator 460, the data decoder 465, and the beamforming receiver 470.

The receiver may include the same random number generator as that of the transmitter and/or the random number generator 460 including the same random number generation algorithm as that of the transmitter, thereby generating the same parameter value and predetermined variable as the parameter value and predetermined variable determined in the transmitter.

As such, the data decoder 465 may restore or assemble the secret data using N share values received from the beamforming receiver 470, the parameter value generated in the parameter determiner 455, and the predetermined variables generated in the random, number generator 460.

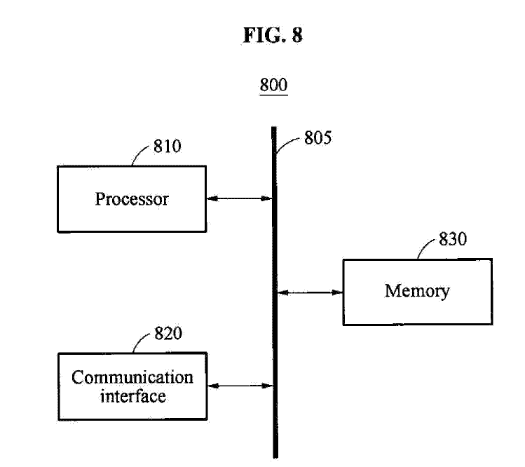

FIG. 8 is a block diagram illustrating a transmitter according to an example embodiment. Referring to FIG. 8, a transmitter 800 may include a processor 810 and a communication interface 820. The transmitter 800 may further include a memory 830. The processor 810, the communication interface 820, and the memory 830 may communicate with one another via a communication bus 805.

The processor 810 may determine a parameter value used to encode secret data based on a number of independent radio channels between a transmitter and a receiver corresponding to the transmitter. The processor 810 may generate predetermined variables used to divide the secret data based on the parameter value. The processor 810 may encode the secret data based on the parameter value and the predetermined variables.

The processor 810 may predict the number of independent radio channels between the transmitter and the receiver based on radio channel information of the transmitter and the receiver, a number of antennas of the transmitter, and a number of antennas of the receiver.

The processor 810 may determine the parameter values including N and K based on the number of independent radio channels, N being, a number of partitions by which the secret data is to be divided into data fragments and K being a minimum number of data fragments required to decode the secret data among the divided data fragments.

The processor 810 may further include a random number generator (not shown) to generate predetermined variables used to divide the secret data based on the parameter value. The predetermined variables may include, for example, a predetermined decimal value used to divide the secret data, K−1 random variables, K being the minimum number of data fragments required for decoding the secret data, an index value of a transmission channel, and a variable for data fragments required to decode the secret data.

The processor 810 may include the channel information manager 410, the parameter determiner 415, the random number generator 420, the data encoder 425, and the beamforming transmitter 430.

The communication interface 820 may transmit the encoded secret data to the receiver using a plurality of antennas.

The memory 830 may store the secret data to be transmitted to the transmitter, the parameter value determined by the processor 810, and the predetermined variables generated by the random number generator. The memory 830 may be a volatile memory or a non-volatile memory.

The processor 810 may perform at least one of the methods described with reference to FIGS. 1 through 7 or an algorithm corresponding to at least one of the methods. The processor 810 may execute a program and control the transmitter 800. A program code executed by the processor 810 may be included in the memory 830. The transmitter 800 may be connected to an external device, for example, a personal computer or a network via an input and output device (not shown) to perform data exchange.

Although not shown, similarly to the transmitter 800, a receiver may also include a processor, a communication interface, and a memory. The processor of the receiver may estimate divided secret data by filtering and demodulating a signal transmitted from a transmitter and decode secret data from the divided secret data based on an encoding function used for encoding the divided secret data and receiving the secret data. In this example, the processor of the receiver may decode the secret data from the divided secret data inversely using the encoding function used for encoding the divided secret data based on a parameter value and predetermined variables shared with the transmitter.

The processor of the receiver may include the channel information manager 450, the parameter determiner 455, the random number generator 460, the data decoder 465, and the beamforming receiver 470.

According to example embodiments, it is possible to encrypt secret data using a parameter value determined based on a number of independent radio channels between a transmitter and a receiver and predetermined variables generated by a random number generator, thereby protecting the secret data through a process of dividing and assembling the secret data even when an encryption key is exposed.

According to example embodiments, it is possible to selectively control a reception rate of a receiver and an, eavesdropping rate of an eavesdropper by encoding secret data by adjusting a parameter value determined based on a number of independent radio channels between a transmitter and a receiver and predetermined variables generated by a random number generator.

According to example embodiments, it is possible to safely transmit secret data by encoding the secret data based on predetermined variables generated by a random number generator unless the predetermined variables are exposed.

According to example embodiments, it is possible to enhance a security of secret data by blocking an environment where an eavesdropper terminal can eavesdrop since all items of data fragmented from the secret data may not be acquired even when predetermined variables generated by a random number generator are exposed.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of transmitting secret data, the method comprising:
determining a parameter value used to encode secret data based on a number of independent radio channels between a transmitter and a receiver corresponding to the transmitter;
generating predetermined variables used to divide the secret data based on the parameter value;
encoding the secret, data based on the parameter value and the predetermined variables; and
transmitting the encoded secret data to the receiver.

2. The method of claim 1, wherein the determining of the parameter value comprises:
predicting the number of independent radio channels between the transmitter and the receiver based on radio channel information of the transmitter and the receiver, a number of antennas of the transmitter, and a number of antennas of the receiver.

3. The method of claim 1, wherein the determining of the parameter value comprises:
determining a parameter value including N and K based on the number of independent radio channels, N being a number of partitions by which the secret data is to be divided into data fragments and K being a minimum number of data fragments required to decode the secret data among the divided data fragments.

4. The method of claim 1, wherein the generating of the predetermined variables comprises:
generating predetermined variables used to divide the secret data based on the parameter value using a random number generator.

5. The method of claim 1, wherein the predetermined variables include at least one of a predetermined decimal value used to divide the secret data, K−1 random variables, K being a minimum number of data fragments required for decoding the secret data, an index value of a transmission channel, and a variable for data fragments required to decode the secret data.

6. The method of claim 1, wherein the encoding of the secret data comprises:
encoding the secret data into data fragments corresponding to a number of partitions of the secret data based on the parameter value and the predetermined variables.

7. The method of claim 6, wherein the encoding of the secret data into the data fragments comprises:
encoding the secret data by applying the parameter value and the predetermined variables to a shared encoding function and dividing the secret data into the data fragments.

8. The method of claim 1, wherein the transmitting of the encoded secret data to the receiver comprises:
modulating the encoded secret data into a transmission symbol based on a binarization and modulation scheme; and
transmitting the modulated transmission symbol to the receiver based on a beamforming scheme.

9. The method of claim 8, wherein the transmitting of the modulated transmission symbol to the receiver comprises:
transmitting the modulated transmission symbol to the receiver through a channel path assigned based on the number of independent radio channels.

10. The method of claim 8, wherein the transmitting of the modulated transmission symbol to the receiver comprises:
determining a transmission power used to transmit the modulated transmission symbol based on a preset power distribution value based on the radio channel information of the transmitter and the receiver; and
transmitting the modulated transmission, symbol to the receiver based on the determined transmission power.

11. The method of claim 1, further comprising:
sharing, with the receiver, at least one of the parameter value, the predetermined variables, and an encoding function used for the encoding.

12. The method of claim 1, wherein the radio channel information of the transmitter and the receiver is determined based on channel information sent from the receiver as a feedback.

13. A method of receiving secret data, the method comprising:
estimating divided secret data by filtering and demodulating a signal transmitted from a transmitter; and
decoding secret data from the divided secret data based on an encoding function used for encoding the divided secret data and receiving the secret data.

14. The method of claim 13, wherein the decoding comprises:
decoding the secret data from the divided secret data inversely using the encoding function used for encoding the divided secret data based on a parameter value and predetermined variables shared with the transmitter.

15. A non-transitory computer-readable medium comprising a program for instructing a computer to perform the method of claim 1.

16. A transmitter comprising:
a processor configured to determine a parameter value used to encode secret data based on a number of independent radio channels between a transmitter and a receiver corresponding to the transmitter, generate predetermined variables used to divide the secret data based on the parameter value, and encode the secret data based on the parameter value and the predetermined variables; and
a communication interface configured to transmit the encoded secret data to the receiver using a plurality of antennas.

17. The transmitter of claim 16, wherein the processor is configured to predict the number of independent radio channels between the transmitter and the receiver based on radio channel information of the transmitter and the receiver, a number of antennas of the transmitter, and a number of antennas of the receiver.

18. The transmitter of claim 16, wherein the processor is configured to determine a parameter value including N and K based on the number of independent radio channels, N being a number of partitions by which the secret data is to be divided into data fragments and K being a minimum number of data fragments required to decode the secret data among the divided data fragments.

19. The transmitter of claim 16, further comprising:
a random number generator configured to generate predetermined variables used to divide the secret data based on the parameter value.

20. The transmitter of claim 19, wherein the predetermined variables include at least one of a predetermined decimal value used to divide the secret data, K−1 random variables, K being a minimum number of data fragments required for decoding the secret data, an index value of a transmission channel, and a variable for data fragments required to decode the secret data.
